(19) United States
(12) Patent Application Publication
(10) Pub. No.: US 2006/0075230 A1
(43) Pub. Date: Apr. 6, 2006

(54) Apparatus and method for authenticating access to a network resource using multiple shared devices

(76) Inventors: Leemon Claude Baird III, Colorado Springs, CO (US); Mance Edward Harmon, San Jose, CA (US)

Correspondence Address: FAY KAPLUN & MARCIN, LLP, 15O BROADWAY, SUITE 702, NEW YORK, NY, 10038, US

(21) Appl. No.: 10/958,610

(22) Filed: Oct. 5, 2004

(51) Int. Cl. H04L 9/00

(52) U.S. Cl. 713/168

(57) ABSTRACT

Means that allow multiple users to be authorized to authenticate through a single given mobile device are described. These means apply as well for the case that the number of users is so large the device does not store all of their authentication information in memory simultaneously. These means allow the authentication information to be securely transferred from a server to the device at the time that the user attempts to authenticate. The device utilizes means and methods that allow this information to be cached to speed up communication during periods when only a few users use the single device.

### TECHNICAL FIELD

The present invention relates to secure access of multiple users to multiple network resources. More particularly, the present invention relates to means and methods for secure access to network resources for multiple users.

### BACKGROUND OF THE INVENTION

Currently users that need to securely gain access to network resources, such as servers, databases, virtual private networks, etc., authenticate only once through a single mobile device that is user specific, such as a PDA, smart phone, barcode scanner, laptop. The authentication includes one or a plurality of authentication factors. Further, the single mobile device performs authentication and login to multiple resources using separate passwords or authentication credentials for each resource. The current network access solution is not applicable for the cases when the single mobile device is not user specific and multiple users intend to use the same mobile device for authentication on to the network. The same is valid for the case one user intends to use several different devices to authenticate and gain access to the network resources.

Therefore, means of secure network access are needed for the case multiple users attempt to share the same single device to securely gain access to the network. Means are also needed for the case a single user attempts to securely gain access to the network using several different devices for authentication.

### BRIEF SUMMARY OF THE INVENTION

The present invention refers to means that allow multiple users to securely use the same mobile device for authentication to a network. The present invention also refers to means that allow a single user to use any of the several devices available for secure authentication to a network resource.

The present invention refers to means that allow multiple users to be authorized to authenticate through a single given mobile device, and applies as well for the case that the number of users is so large the device does not store all of their authentication information in memory simultaneously. The present invention refers to means that allow the authentication information to be securely transferred from a server to the device at the time that the user attempts to authenticate. The present device refers to means and methods that allow the device to cache this information to speed up communication during periods when only a few users use the single device.

The present invention refers to a method for providing secure access to network resources for a plurality of users, wherein each user utilizes any single device of a device fleet. The method comprises the steps of selecting a device from the fleet of devices accessible to a user, imputing the user information into the selected device, transmitting the user information to a credentials database server, returning an encrypted user specific credentials database to the selected device, returning to the credential database server an encrypted database key or an acknowledgement, deciphering the user specific credentials database using the encrypted database key, accessing with the selected device multiple network resources, and finalizing the use of the device.

### BRIEF DESCRIPTION OF THE DRAWINGS

The present invention is described with reference to the accompanying drawings. In the drawings, like reference numbers indicate identical or functionally similar elements. Additionally, the left most digit(s) of a reference number identifies the drawing in which the reference number first appears.

FIG. 1 is a block diagram illustrating a connection between a device and a remote site.

FIG. 2 is a block diagram that illustrates in detail the components of a system 100.

FIG. 3 is another block diagram illustrating in detail the components of the exemplary single device.

FIG. 4 is further another block diagram illustrating the data and code stored in a memory of device 100.

FIG. 5 is yet another block diagram illustrating the data and code stored in the memory of device 100.

FIG. 6 is a diagram that illustrates a method of secure access to network resources according to an embodiment of the present invention.

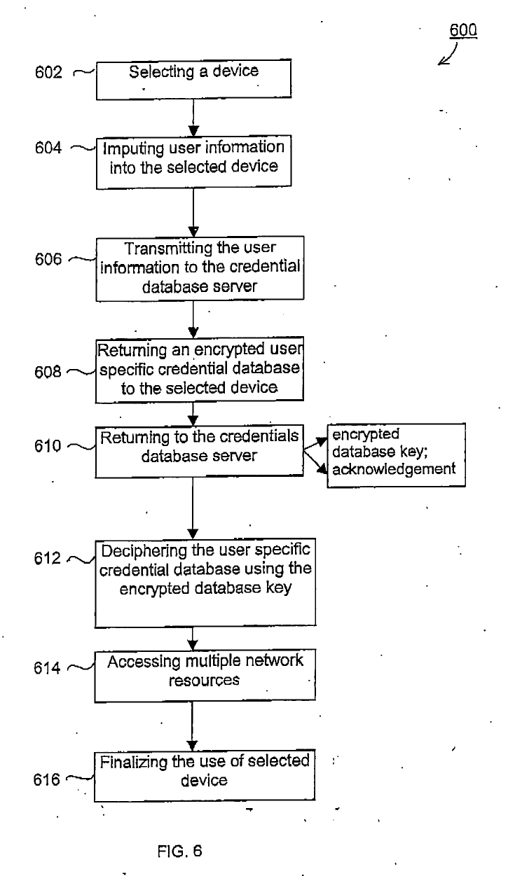

FIG. 7 is a diagram that further illustrates a step of the method shown in FIG. 6.

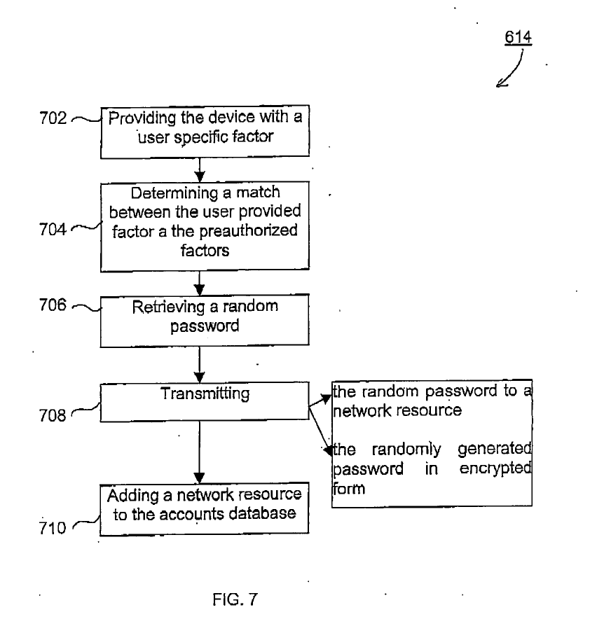

FIG. 8 is a diagram that illustrates a method of access to network resources for a single user.

FIG. 9 is another diagram that further illustrates a step of the method shown in FIG. 6.

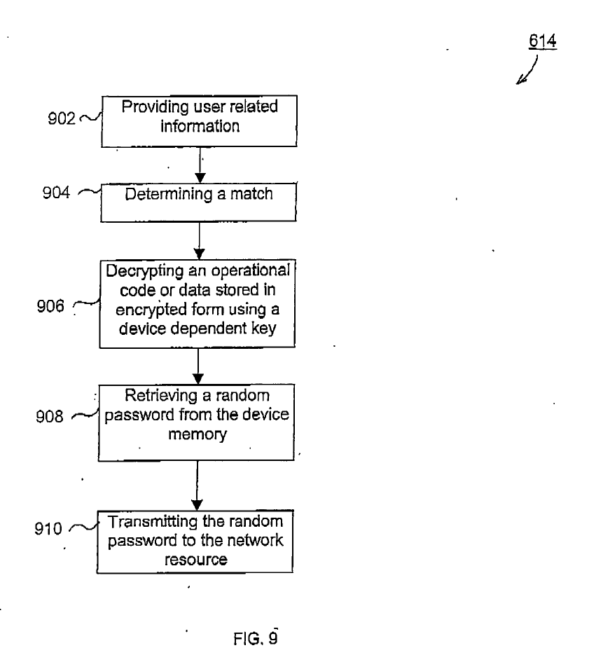

### DETAILED DESCRIPTION OF THE PREFERED EMBODIMENTS OF THE INVENTION

The following detailed description is merely exemplary in nature and is not intended to limit the invention, applications and uses of the invention. Furthermore, the invention is not intended to be limited by any expressed or implied theory presented in the preceding technical field, background, brief summary or the following detailed description.

In the following detailed description of the preferred embodiments, reference is made to the accompanying drawings that form a part thereof, and in which are shown by way of illustration specific embodiments in which the invention may be practiced. It is to be understood that other embodiments may be utilized and structural changes may be made without departing from the scope of the present invention.

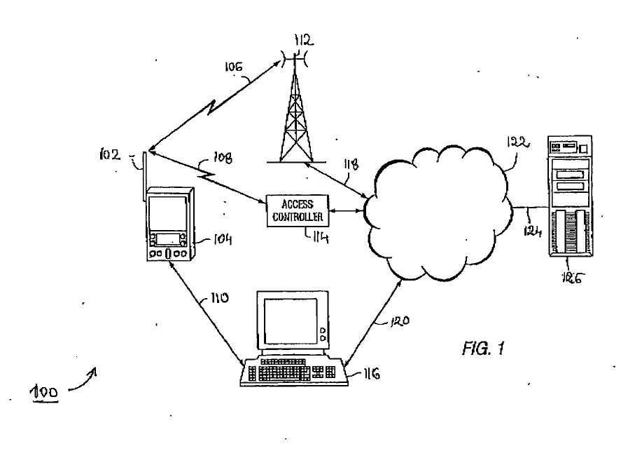

FIG. 1 is a functional block diagram illustrating a connection between a single device and a remote network resource.

A device 104 including data and executable code processing capabilities allows a user to access a site 126. Exemplary embodiments for single device 104 include personal digital assistants, handheld or laptop computers, cellular telephones, smart pagers. In the context of the present document, these devices continue to perform their originally intended function. In addition, a supplemental level of security initially not available with these or other devices, is described.

Generally, the teachings gave therein can be applied to any device that includes processing capabilities (e.g., microprocessor, microcontroller), an input capability (e.g., keyboard, microphone), and an output capability (e.g., speaker, display screen). In addition to those identified above, present and future devices that have or will have such capabilities include: wristwatches, telephones, microwave ovens, televisions, electronic books, hearing aids, surgically embedded computers, etc. The device 104 communicates directly with a site 126 (e.g., an on-line e-commerce site or a server) or other network resource (e.g., computer, printer) through one or more of the several different communication paths illustrated in FIG. 1. One such communication path includes a radio frequency wireless link 122 wherein a radio or transceiver within the device 104 bi-directionally communicates via an antenna 112 with a radio or transceiver at a base station 104. Exemplary embodiments for the communication link 122 include a cellular phone network or a personal communications services (PCS) network. A base station 104 bi-directionally communicates with a network 126 over a wired or wireless communications path 124. Access to network 126 by single device 104 can be gained over a communications link 108 with an access controller 114, which is functionally integrated into network 122. Exemplary embodiments can be implemented with Bluetooth or IEEE 802.11 standards. One possible embodiment contemplates that the information communicated over the various links illustrated in FIG. 1 is in encrypted form.

Device 104 also communicates with network 122 via a computer 116. Link 124 is implemented by one of a wired connection, an infrared connection, optical fiber cable, a radio frequency communication connection, based on either Bluetooth or IEEE 802.11, or other links known to those skilled in the art. Link 120 is implemented based on the same or similar communications schemes with those implementing link 124. Depending on the specific exemplary embodiment, the network 122 incorporates one or more of the following communication devices and network types: the Internet, local area networks, servers, routers, bridges, firewalls, public or private land-based communication lines, wireless services and infrared services.

Typically, an user interacting with single device 144 desires to access multiple sites, for example sites like 126, via network 122 and a communications link 124. Each site 126 has multiple accounts therefore multiple users can access the site, each employing its own identification and access protocol. Further, each account at each site requires entry of a user password to gain access. Each communication link or path illustrated in FIG. 1 is generally insecure and subject to traffic monitoring and data alteration by a user's opponent or adversary. In an effort to improve the security of the transaction, device 104 and site 126 typically encrypt the information communicated between them over network 122 so that adversaries monitoring the network 122 or unknown devices operating on the network cannot detect, decipher or modify the information in transit. Typical encryption protocols include a secure sockets layer (SSL) protocol used by web sites with an https:// address or the secure HTTP (S-HTTP) protocol. The various communications links shown in FIG. 1 can also be encrypted. For instance, the Bluetooth wireless standard referred to above includes an encryption protocol for use on Bluetooth links.

Like network 122, computer 116 that is typically a personal computer, laptop computer or work station in a home, office or cyber café, is not a trusted device. As mentioned above, computer 116 may include virus infections or other malicious code unknown to the computer user.

The various communications links illustrated in FIG. 1 are intended to provide alternative paths for accessing network 122 from device 104. The types of communication elements incorporated into device 104 dictate which communication path and techniques are utilized by device 104. For example, if device 104 is always used proximate to computer 116, then a infrared communication path is used to establish the communication link between them. In this exemplary embodiment, device 104 does not need to include a transceiver for accessing the base station 112 or the access controller 114. Alternatively, if the device 104 is used in a remote or field setting, likely the communication path 122 is implemented with the technique of choice and therefore, device 104 requires a radio frequency receiving and transmitting apparatus for operating on communications path 122 and communicating with the base station 112.

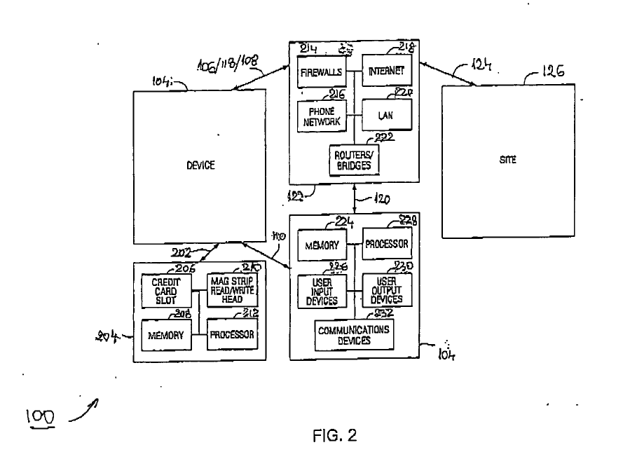

FIG. 2 is a block diagram that illustrates in detail the components of system 100.

Computer 104 comprises a memory 224, user input devices 226, a processor 228, and user output devices 230. These are conventional elements of a computer and are well known to those skilled in the art. The computer 104 also comprises one or more communication devices 232. The specific capabilities of the communication devices are determined by which communication path is implemented in a specific application of the present invention. The communication device 232 comprises a radio frequency receiver and transmitter (transceiver), optical communication devices and infrared communication devices, each incorporating the necessary protocols, hardware and software elements, as determined and required by the communications scheme employed.

As shown in detail in FIG. 2, and as discussed in conjunction with FIG. 1 above, network 122 represents either the Internet 218, a local area network 220, or a public or private telephone network 216. These networks include firewalls 214, routers/bridges 222, and any other computer or communication apparatus required for connectivity. The various communication links operative in network 122 are the same as the ones represented in FIG. 1.

As shown in an exemplary embodiment illustrated in FIG. 2, device 144 is further connected to a credit card writer 204 via a communications link 202. The credit card writer 204 includes a credit card slot 206 for inserting a credit card carrying a magnetic strip. A magnetic read/write head 210 changes or encodes new data on the credit card strip. The credit card writer 204 in one embodiment also includes a memory 208 and a processor 212 for controlling the strip reading and writing processes.

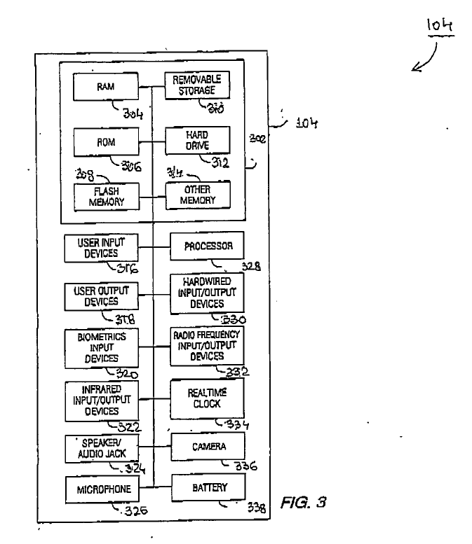

FIG. 3 is another block diagram illustrating in detail the components of the exemplary single device.

In one exemplary embodiment, device 104 is a handheld device. Various other embodiments include features associated with a personal digital assistant (PDA), a window CE based digital assistant, a “smart” cell phone or a “smart” beeper. Device 104 further includes specific hardware and software elements, as taught above in the present document, such as a finger print reader and tamper-resistant memory. Device 104 includes a memory module 302 having various memory and storage elements included therein. The memory module 302 comprises a random access memory (RAM) 304, a read only memory 306, and a nonvolatile memory 308, such as flash memory or random access memory that is backed up by a battery or other electrical storage device. The memory module 302 further includes removable storage 310, that is a memory stick or memory expansion card, a hard drive 312, and other memory devices 314. Typically, the memory module 302 stores both executable software code and data. Because several different types of devices can serve as hardware platform for device 104, the specific characteristics and features of the software code and data stored therein are directly dependent upon the hardware platform. Further, the software code and data elements and the hardware elements include elements particular to the present invention.

Typically, a software code and the data stored in the memory module 302 is backed up automatically or by the user using conventional memory backup processes. For example, a typical personal digital assistant allows code and data stored in memory to be backed up to a computer. It should be noted, however, that the device dependent key feature of the present invention might not backed up in accordance with standard memory back up procedures.

Device 104 further comprises at least one user input device 316 such as keyboard, pen input, or touch screen, at least one user output device 318, such as a display screen, Braille output or a video output jack, at least one biometrics input device, such as a fingerprint reader, infrared input/output devices 320 for communicating with, for instance, computer 116, speaker/audio jacks 324, and a microphone or an audio input jack 326 for providing audio input, especially voice, to device 104. Device 104 further comprises a processor 328 for executing the software code and processing the data associated with both the conventional features of the device 104 and those additional features associated with the present invention. Hardwired input/output devices 330 can, in various embodiments, include a serial port, a parallel port, a cradle connection, a universal serial bus port or a firewire port. Radio frequency input/output devices 332 include in various embodiments a receiver, transmitter, transceiver and any other elements required to communicate via multiple communications links. Device 104 further comprises a real-time clock 334 and a battery 338 for providing electrical energy. In one embodiment, the device 104 also includes a camera 336.

As discussed above, single device 104 can be one of many different platforms that provide specific functionality for the user. Single device 104 is upgraded with additional elements that allow the device 104 to operate as a trusted device, that is, a device requiring user authentication. The user proves his or her identify to the device 104 in various ways using one or more multiple techniques. They include the use of a password, biometrics input, and physical possession of the single device. Once the user has been authenticated the device 114 provides the user with access to site 126 using strong passwords that are changed frequently and remain unknown to the user. Device 104 can also take advantage of existing secure communication techniques such as the Windows-based secure sockets layers, for exchanging information with the site 126. Further, device 104 interfaces with “insecure” machines, such as computer 116, but the transaction details are controlled from and displayed only to the user via device display. The transaction details are not displayed on the insecure computer 116 and the communications link between device 104 and computer 116 operates in a secure or encrypted mode. Others with access to the computer 116 can therefore not modify or control the transaction and further viruses residing on the computer 122 are unable to intervene in the transaction. 114. The computer 116 sees only a string of encrypted bits. The bits cannot be read, understood or changed by computer 116 because the transactions with site 126 are controlled and monitored from device 104. In the unlikely event that computer 116 was capable of making a change to even one bit, the change would be detected by device 104 and site 126. Thus device 104 provides a secure link to a trusted site via an untrusted computer 122.

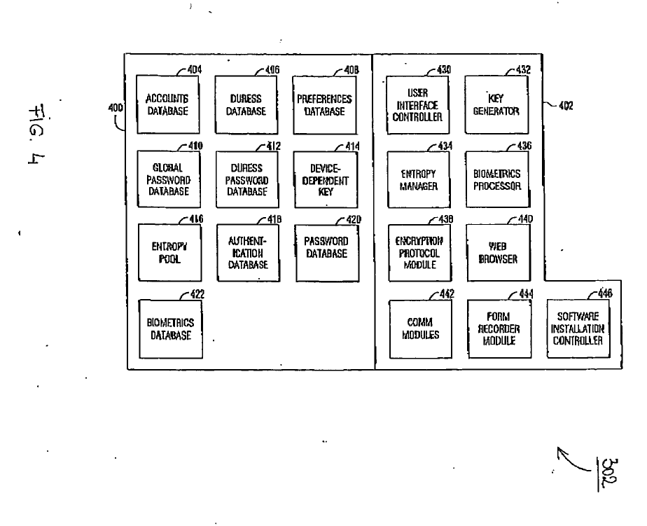

FIG. 4 is further another block diagram illustrating the data and code stored in the memory of device 100.

FIG. 4 illustrates certain elements of the memory module 302 as segregated between a data module 400 and a code module 402. In one embodiment of the present invention, the information stored in the data module 400 is stored in encrypted form and decrypted only as required during the operation of device 104.

After the user has been authenticated to device 104, the user is given access to accounts, resources, and/or sites database 404, where each account name, user identification and password for the user-accessible accounts is stored. The account name describes the account or site with an identifier recognizable to the user. As discussed further below, the device 114 displays the account name when the user desires to select an account for access. The user identification and password associated with each account or site are account specific. That is they are dependent upon the process and data entry required for accessing the account. The account name may also include the uniform resource locator (URL) of the account in the Internet or local area network.

In an exemplary embodiment, device 104 includes a feature that prevents attackers from gaining access to accounts database 404 and makes certain that the accounts stored, especially if they contain sensitive data can not be accessed and released if such would be detrimental. Therefore, if the user is under pressure or is being threatened to reveal the global password, for example one of the three authentication processes employed according to the present invention and discussed further below is revealed, to gain access to the device 114 and thus the accounts database 404, the user instead reveals or enters a duress password. The device 104 responds to the duress password in an apparently normal fashion, but unknown to the attacker, the duress password provides access only to those accounts listed in a duress database 406. Thus, the accounts in the accounts database 404 are protected from disclosure and access by the attacker. The attacker cannot determine that the entered password is false. The duress database 406 is accessed when the user enters the duress or fake password; the accounts database 404 is not accessible with the duress password. The duress database 406 is structured similarly with the accounts database 404, but contains only those accounts that the attacker can see and access without compromising the user. Those accounts within the accounts database 404 that would compromise the user if accessed by an adversary, are not repeated in the duress database 406. Further, when the user enters the duress password, the accounts database 404 is permanently deleted. To avoid creating any suspicions within the attacker, the duress database 406 can include a few legitimate accounts, but only those that will not cause any harm if accessed by an attacker.

A preferences database 408 includes selected user stored options including, the length and change frequency for the account passwords, for example monthly, daily or at every log in. The preference data base 408 also includes a selectable option for enabling the duress password function and other options related to the entry mode for the global password, which is the password entered by the used to authenticate to the device 104. For example, in one embodiment, the global password is combined with biometrics information, requiring the user to “sign” the password rather than entering the password through keyboard strokes. The preferences database further includes instructions as to whether the user can see the account passwords, add new accounts or change any of the preferences. In certain applications, the preference data base 408 may not be modifiable by the user. For example, if a corporate organization issues the device 104 to a user, the device 104 may be configured with certain preferences as desired by the employer. In this way, the employer controls the security of the resource access process via the device 104, by for instance, not permitting the user to change the password modification frequency. For maximum security, the preferences database 408 can be configured for optimum password security by requiring an account password to be changed at each log in. Giving the user the ability to change this preference to a monthly password update, might compromise site access process.

A global password database 410 stores the correct user or global passwords that the user enters to gain access to the device 104. In one embodiment, the global password can be merged with biometrics information. For example, if the biometrics involves an analysis of a handwritten signature, then the user may choose to sign the password instead of entering the password via a keyboard (or Graffiti input) then writing the signature. Combining the global password with the biometrics reduces the authentication time because the biometrics requirement and the password entry are accomplished in a single action.

Obviously, it is more convenient to sign the password to accomplish the password and biometrics entry simultaneously, but this process is also less secure. For example, if the user loses the device 104, a very sophisticated attacker could possibly read out the memory contents. If the contents of memory are encrypted, then the user will not obtain any useful information. Therefore, the device provides an extra layer of security whenever the memory contents are encrypted. But, if the memory information is stored in encrypted form then a user must enter a user or global password in a form readily discernable by the device 104. The device 104 must be able to understand and interpret each letter of the password (entered via a keyboard or special Graffiti language). Alternatively, if the user signs the user password, the device 104 cannot interpret the written word because the all the device sees is a single scribble. The device 104 can determine whether the scribble is an authorized one (to authenticate the user), but cannot determine exactly the individual letters in the scribble and therefore cannot test the password against the authorized passwords. Thus two device options are available. If the memory contents are not stored in encrypted form the password can be signed. If the memory contents are encrypted, the user can first sign a word or phrase for the biometrics authentication process then enter another password in the form of individual distinct letters.

A duress password database 412 stores the duress password discussed above. In one application of the teachings of the present invention, a plurality of users can be permitted use of a single device 104. In this situation, the global password database 410 and the duress password database 412 store the global password (also referred to as the user password) and the duress password for each authorized user. The duress password is entered into the device 104 in a manner identical to entry of the global password. A third party observing password entry cannot determine whether the user has entered a duress password or the global password. The device 104 responds to both passwords in the same manner. When the user enters the duress password, the account database 404 is deleted and the contents of the duress database 406 are copied into the accounts database 404. Entry of the duress password, followed by successful completion of the remaining authentication steps, allows access only to the accounts listed in the duress database 406. Therefore, when the device 114 is configured, the user or issuing party should include only non-sensitive accounts in the duress database 406.

As noted above, there are several independent processes for authenticating the user to the device 104: what the user has (the device 104), what the user knows (the global or user password), and what the user is (as determined by the user's biometrics).

The first requirement limits access by the user to only those accounts previously stored within the accounts database 404 on a specific device 104 intended for use by a specific user. For example, if an employer issues the device 104 to all employees, each employee will be able to access those accounts as established by the employer and as set forth in the accounts database 404. The employer may, for instance, allow each employee to access only the corporate servers and not access any Internet accounts. If the user loses the specific device 104 assigned to him or her, it should not be possible, to ensure that security is not compromised, for the user to buy a replacement device, restore the backed-up data to the replacement device and use then use replacement device. According to the teachings of the present invention, the user must instead request a replacement device from the employee at which time the identity of the user can be checked by security personnel. The employer then activates a new device 104 and stores in the accounts database 404 only those accounts to which the employee is permitted access.

The inability of the user to purchase a replacement device 104 and load it with the backed-up contents of a lost device is controlled by a device dependent key 414. The device dependent key 414 is a random key stored unencrypted in the data module 400 (i.e., long-term memory). The device dependent key 414 is required to decrypt the encrypted data in the data module 400, including decryption of the user's global password. The device dependent key 414 is not visible to the user, cannot be changed by the user, and is not backed up when the code and data stored in the device 104 is backed up. Thus, if a user loads backed-up data from a lost device to a new device, the device dependent key is not loaded to the new device and thus the data in the new device cannot be decrypted and therefore the new device will not function. A related situation where the device dependent key 414 serves an important function occurs when the teachings of the present invention are applied to a personal digital assistant and the user backs up the contents of the personal digital assistant to a desktop computer. According to the present invention, the contents of the memory modules 400 and 402 are backed up in encrypted form. An attacker cannot derive the contents of the memory modules 400 and 402 from the backed up data, because the device dependent key is not backed-up, but is required to decrypt the backed-up information.

The device dependent key 414 is created by the issuing organization, who maintains a copy of it. If the device 104 is lost or stolen, the user must request a new device from the issuing organization. Generally, the new device 104 uses the same device dependent key 414 as the lost device. The device dependent key optional feature according to the teachings of the present invention ensures that an attacker or opponent cannot recover data stored within the device 104, even if given access to encrypted back-ups of that data, the user's global password, and a copy of the user's biometrics. The device dependent key 414 serves as a tie between a specific device 104 and the contents of that device. Loading the backed-up data onto another device and using an authorized user's global password and biometrics will not allow access to the accounts database 404 from a different device. That is because the different device does not have the device dependent key 414 required to decrypt the stored information and the user's password. The device dependent key 414 cannot be backed up and therefore cannot be transferred to another device 104.

The device 104 uses an encrypted communication protocol (e.g., utilizing the secure sockets layer) and also encrypts the data in the device 104. Both of these functions require truly-random numbers that are not simply the output of an algorithm. Algorithms are predictable, and an adversary must not be able to predict these numbers. If the device 104 includes a true random number generator (TRNG) hardware or software. When implemented in software as executed by the processor 328, the executable code of the device 104 uses the generated random numbers for the encryption and decryption processes, as required. Alternatively, the device 104 maintains an “entropy pool” to aid in generating random numbers for the decryption and encryption processes. The entropy pool is a list of truly-random numbers.

In this alternative embodiment, whenever a process executed by the device 104 requires a random number, it is selected from an entropy pool 416 of the data module 400. After each selection, the entropy pool size shrinks. Random numbers are added to the entropy pool 416 each time the user interacts with the device 104.

For instance, when the user pushes a button, writes on the display, or talks into the microphone 326, the exact time and the nature of the interaction are recorded. As is well known to those skilled in the art, these user inputs cause the creation of additional random numbers that are added to the entropy pool 416. Inputs from the various networks with which the device 104 communicates (see FIG. 1) are also used to produce additional random numbers. The entire entropy pool 416 is then hashed or scrambled. There is no known way to unscramble the entropy pool 416 after the hashing process. The bits in the entropy pool 104 are then analyzed to determine the number of truly random bits.

Whenever random numbers are needed, for example for creating passwords or for salts, initializing vectors during encrypted transmission, random bits are removed from the entropy pool 416 and the entropy estimate is accordingly recalculated. In the event that random bits are needed when the entropy pool 416 is depleted, the device 104 prompts the user to create more entropy bits through random inputs. Inputs can be provided by simply pushing buttons, scribbling on the pen input for the device 104 or talking into the microphone 326. In one embodiment, the entropy pool 416 is not backed up during the memory backup process executed by the device 104.

The authentication database 418 stores details of the access process for each of the accounts listed in the accounts database 404. The process executed by the device 104 for obtaining the access information from each of the account resources is discussed below. In the case of a web site, for example, the information stored in the authentication database 418 includes the format for submitting user identification and password information to the web site. The process of logging on to a web site is performed by the device 104, and in one embodiment is not visible to the user via any of the user output devices 336. For other sites to which the user has access, the authentication database 418 includes the necessary addresses and protocol information required to access the site (e.g., a network server).

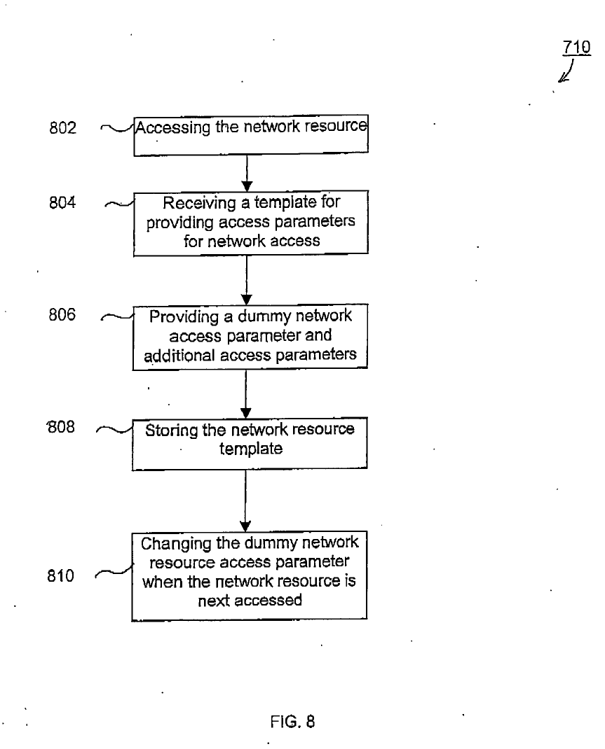

A password database 420 stores information describing the process for changing the password for the sites in the account data base 404. The password database 420 includes the site-specific format for submitting the user identification data, the old access password and the new access password. As discussed above, the device 104 is programmed to change account passwords at an interval set forth in the preferences data 408. The process of changing passwords for accessible sites is performed without user intervention. For example, if the preferences data base 408 indicates that a specific site password is to be changed every time the user logs in, the device 104 proceeds to carry out that command each time that account is accessed. This process is discussed further below in conjunction with FIG. 8.

Information for verifying a users biometrics is stored in a biometrics database 422. Exemplary biometrics data includes information on the path and speed of a pen during signature, fingerprint descriptions, iris scans and voice prints. In one application of the device 104, several users are authorized to use a specific device and therefore the biometrics database 422 stores biometrics for each of the authorized users.

Software code stored within the code module 402 is stored without encryption. Although this code may be stored temporarily in the random access memory 332 during execution, there is no long term storage of the data in the code module 402.

A user interface controller 430 of the code module 402 controls the user interface of the device 104, offering the user operational options and presenting a list of sites that are accessible. In essence, the interface controller manages all input and output operations between the user and the device 104.

A key generator 432 generates new random account passwords for use in accessing the accounts in the accounts database 404. The account passwords are generated using the entropy pool 416. The generated passwords can optionally be made pronounceable and/or viewable on the screen of the device 104. In one embodiment the account passwords are not displayed on the device display; in another embodiment the account passwords are displayed. The choice of the operative embodiment is selectable by the user. For example, a user may use the device 104 in locations and situations where the device 104 cannot be connected to a computer (i.e., the computer 116), such when there is no pre-established communications link between the device 104 and the computer 116 (in a cyber cafe, for example) and when a cradle for interfacing the device 104 to the computer 116 is not available. Another situation where the password should be visible on the device display is when the user calling technical support for a site or network resource via a telephone, and the user must reveal the password to the technical service personnel. When the computer 116 is not available, to access the site, the user types the account password directly into the device 104. When the computer 116 is available, the device communicates the password to the computer 116 in encrypted form and the computer 104 transmits the password to the site 126. Recall, as discussed above, that the computer 116 includes a web browser for interfacing with the site 126. The latter embodiment where the password is visible on the device screen offers the better security. Note that if an employer distributes the device 104 to its employees, the employer can set the preferences (as stored in the preferences database 408), and prevent the user from changing them. One such preference involves the choice of a displaying the password.

The entropy manager 434 controls the entropy pool 416, as discussed above, including the generation of new random numbers.

The biometrics processor 436 compares biometrics input from the user with stored biometrics information (in the biometrics database 432) for authorized users for determining whether the user is a permitted user of the device 104.

The encryption protocol module 438 manages the secure communications between the device 104 and the site 126. One example of such a protocol is the secure sockets layer (SSL). This protocol is used by those worldwide web sites having an address of the form “https://”. Use of existing secure protocols (such as the secure socket layer) together with the security features offered by the device 104, allows communications over an encrypted link with existing web sites, while providing security features by way of the device 104 beyond those provided by existing communications system protocols. The encryption protocol module 438 also includes encryption and hash algorithms, for instance, for use by the entropy manager 434 and to encrypt data bases backed up by the device 104.

A web browser 440 controls sessions between the user operating the display 104 and the accessed web site, for instance the site 126. The web browser 440 displays web site information on the device display and further accepts input from the user via the user input devices 332 of the device 104. In another embodiment, the device 104 also permits the untrusted computer 122 to display web pages and accept user input. In that embodiment, however, the device 104 encrypts the account passwords and other confidential information (e.g., details of a stock transaction) passing between the site 126 and the device 104. The computer 116 cannot interpret or understand the random bits that it sees and so cannot intercept the password or alter the confidential details of the transaction.

A communications module 442 manages all communications aspects of the device 104, including the various communications links illustrated in FIG. 1. Exemplary communications types managed by the communications module 442 include: infrared, cellular telephone and personal communications services, Bluetooth, all types of radio frequency based communications, connection to a cradle, and connection to the external credit-card writer 218.

The software within a form recorder module 444 allows the user to access a new Web site, and controls the site sign-on process of entering a user identification and password for future access to the site. Under control of the Web browser 440, the user goes to the site page and enters a standard user identification, in one embodiment, the identification can be “USER”. A standard password, in one embodiment “PASSWORD”, is then entered. The site will not accept this identification information and password, but through this process the device 104 has stored the layout of the form that was returned to the site. For future logins to the site, the device 104 replaces “USER” with the user identification and replaces “PASSWORD” with the network resource password, as generated by the entropy manager 434, as discussed above. The site or network resource captures the entered password and thereafter this password is required for access to this site. However, as discussed herein, the password is frequently changed, is generated randomly and is not known to the user. Thus a “strong” password has been created and the security associated with accessing the site improved significantly. This process of learning the site template must be executed only once for each site or account in the accounts database 404.

In an application where the device 104 is issued to the user by an issuing organization, the device 104 can be preloaded with site specific information, thereby avoiding execution of the site entry process described above. When the site 126 is a web site, the form recorder module 444 also stores the uniform resource locator of the web site, the parameters of the web site form for entering the user identification and password when authenticating to the web site and the cookies to store from and send to that web site. If the site 126 is on a local are network (for example, a network server) then the stored data includes the network address, the user identification and password and any additional information needed to authenticate to the local area network device.

A software installation controller 446, installed in one embodiment of the device 104, modifies the device operating system such that no additional software can be installed on the device 104. That is, the software on the device 104 is frozen and no additional programs, operating system software or executable software can be installed. This feature of the device 104 prohibits the introduction of virus software or other malicious code. If it is later desired to install new software, the operating system software must be reset, which erases certain data and executable code stored in the memory modules 400 and 402, and the user must then reinstall all the software and data for proper operation of the device 104.

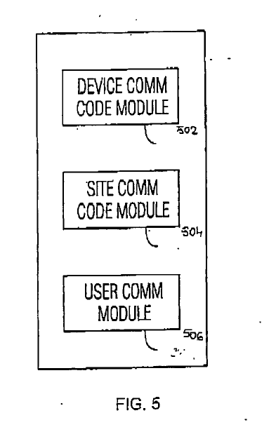

FIG. 5 is yet another block diagram illustrating the data and code stored in the memory of device 100.

FIG. 5 illustrates certain elements of code and data stored within the memory 224 of the computer 116. The executable code resident on the computer 116 is simpler than the code on the device 104 in the embodiment where the computer 116 serves primarily as a conduit for data passing between the device 116 and the site 126. However, the computer 116 can in fact be a fully functional computing device, but all the attributes of the computer 116 will not be utilized when operating with the device 104, so as to ensure the security features in accordance with the teachings of the present invention are operative.

A device communications code module 502 stores software for communicating with the device 104. The specific nature of the stored code is dependent upon the type of communications link or links available between the computer 116 and the device 104. In operation, the device 104 provides the computer 116 with data to send to the site 126. The computer 116 receives data from the site 126 and transmits it back to the device 104. In one embodiment, the computer 116 and the device 104 can encrypt the information passed between them. This embodiment requires that both the device 104 and the computer 116 include an encryption key, for instance as contained within the encryption protocol module 438 of the device 104. In this embodiment, the device 104 functions only with the specific computer 116 in which a decrypting key has been installed. Such a decrypting key can be stored within the device communications code module 502. Situations requiring high security between the device 104 and the computer 116 suggest the encryption of the communications link operative between them. As an additional security device, the device communications code module 502 is configured to require that before specific accounts (stored in the accounts data base 404) are accessed, a certain group of users or all users must cooperate in some way to access that account. This feature adds an additional layer of security to the process of accessing sites 126 from the device 104. Finally, as discussed above,

A site communications code module 504 communicates with the sites 126 via the network 122. For accessing web sites, the site communications code module includes browser software. Other site specific software is may be required, depending upon the sites or other resources to which the user of the device 104 has access.

A user communications module 506 communicates with the user of the computer 116, such as through a web browser or other graphical user interface displayed on the computer display screen. Inputs from the computer user can be sent to the device 104 and the device 104 can send data to the computer user, both of which appear on the computer display, under control of the device communications code module 502. As discussed above, the device 104 encrypts the information transferred to the site 126 via the computer 116. Also, the site 126 encrypts the information that it sends to the device 104. In particular, the site password is encrypted. Thus the untrusted computer 116 cannot intercept, modify or divert information passing between the site 126 and the device 104 in encrypted form. At the user's election, non-secure information can be communicated between the device 104 and the site 126 in unencrypted form so that the computer 116 can participate in the data exchange process, by, for example, displaying information on the computer display.

While using the scenario depicted in FIG. 1, the user first proves his or her identity to the device through one or more factors. One possibility is to use a three-factor authentication method. Possible factors are “what you have”, “what you know”, “what you are”, “where you are” and/or many others.

“What you have” factors entail that the authentication only works when using a particular device. While using “what you know” factors the user must enter a password. “What you are” factors entail that the user authenticates using biometrics, using fingerprints or handwriting recognition. “Where you are” factors presume that wireless transceivers triangulate the location of the user, allowing access only from certain locations. Any number of other possible factors is allowed.

After authenticating to the device once, as described above in connection to FIGS. 1 to 5, the device is further authenticated to the network resources or to the networked devices. For example, the authentication to the network resources may be made by the device using passwords. The authentication to the network devices may be made by the device to door locks or appliances by using control codes that are sent wirelessly to the appliance.

These access and authentication procedures are secure because the connection from the device to the resource is encrypted. This single-sign-on solution is done using a database of passwords and codes kept in the device. This database of passwords and codes is a credentials database. This plurality of passwords and codes allow the device authenticate automatically to the resources. Therefore, the user does not need to remember or even know the passwords.

A credentials database is stored in the device, and is also backed up. For example, if the single device is a PDA, the credentials database is backed up during a normal hot sync to the user's PC. This is secure because the information in the credentials database is encrypted. The encryption is realized using the user's password and a device-specific key. The device specific key is a key stored only in that particular device, and which is not backed up during a hot sync. If a biometric device is being used, their identification specifications are stored also in the credentials database, and are used when the user authenticates to the device.

In the scenario that a large number of users shares a large number of devices, automatic downloading of credentials occurs from the credentials database. The present document addresses this scenario and aims to provide a solution for the case that secure access to network resources needs to occur for a large number of users that share a large number of devices.

Example of such a scenario is a hospital environment where different medical personnel shares a number of medical devices, such as defibrillators, surgical tools, etc. Another example is a warehouse environment where a plurality of mobile computers pertaining to the warehouse is being used by a group of warehouse workers. The medical personnel needs secure access to the hospital facility network resources or to a diagnostic resource while is using any of the surgical tools available in the hospital. This allows to have a different number of surgical tools than the number of medical personnel that will be using them and also prevent the unwarranted access of an outsider to the tools and the hospital network resource. The same is valid for the warehouse example where access to a prices and inventory database that is stored on a network is warranted through a plurality of mobile computers to a plurality of different employees that need secure access to the network resources.

The present document describes a solution for a large number of users. The solution allows a large number of devices to gain access to a large number of devices through automatic downloading of the credentials database.

A central administrator assigns and decides which users can use which devices for access to a particular network resource from a particular location. The central administrator will assign which users can use which devices for access to which network resources from which locations.

Each user is assigned a unique username. The user name is a name, an employee number, etc. The users will authenticate to a device. Examples of possible devices are PDAs, smart phones, barcode readers, laptops, workstations, etc.

The authentication process follows a succession of steps like the one described below. The user picks up a device and enters its information. As a consequence, the device sends this information to a credentials database server. The credential database server is a server that stores the credentials for each user. The information sent may include: the username, a device identifier, possibly information related to location, possibly information related to caching. A device identifier is a unique name or number for the device. The possibly information related to location, if available, originates from GPS or wireless triangulation, etc.

The credentials database server sends the device the credentials database for that user. That database is encrypted with a database key, that is a key used to encrypt the database before it was first put on the server. The server sends the device the encrypted credentials database. This encrypted credentials database can be the same as what the device in the single device—single user scenario would have backed up during hot syncs and will be identical no matter which device it is sent to.

Subsequently the database key is encrypted with the device key, if one is available and user password, again, if one is available. If the user is authorized to use multiple devices, then the server sends the same encrypted database no matter which is the device the user is using, but a different encrypted database key that depends on which device the user is using. Another possibility is that the server sends a simple acknowledgement message instead of the above two items.

Afterward the user authenticates to the device, using one or more factors from a plurality of predefined factors. Any number of factors, including the four mentioned earlier in the document can be used.

Next, the device decrypts the credentials database using the device key, and the user password, if any available.

If biometrics are enabled, the device requires the user to enter biometric credentials, such as a fingerprint scan or a handwriting sample and it compares the biometric credentials to a template that was stored in the credentials database. If they do not match, the user will try again, possibly erasing the decrypted database after a certain number of failed tries.

If location is one of the factors, the device determines its location, for example by GPS or by WiFi triangulation, and will only allow the user to access some of the network resources in the database. The credentials database will contain information on which resources are allowed to be accessed only from particular locations.

Alternatively, the credentials database server may have access to location information directly. For example, the device may be accessing the server through a wireless connection, and the server can poll various wireless transceivers to triangulate the device's location. If that capability is present, then the server could be given several credentials databases for a user, with each database containing credentials for only those resources that are allowed to be accessed from a particular set of locations. In this scenario, the device does not have to decide which resources the user can access. The user can simply access all resources in the particular database that the server sent. This is more secure than allowing the device to make that decision, but it may require additional hardware and software to give the server that capability.

After proceeding according to the succession of steps described above the device becomes a single-sign-on solution. The user can access multiple network resources through the device, and the device transparently uses the decrypted credentials database to authenticate to those devices. For example, if the device is wireless and the user roams to a new location, breaking the current Virtual Private Network (VPN) connection, then the device should automatically log in to the VPN with the appropriate password once the wireless connection is reestablished. Or, if the user needs to access an application on a server on the network or Internet, the device should transparently authenticate to that application using passwords, or Public Key Infrastructure (PKI) certificates, or whatever other credentials the application requires. The device will have the database key sitting in memory unencrypted throughout all the time that the user is using it. The database itself, however, can be left encrypted most of the time, only decrypting it (or parts of it) as needed.

At the time the user concluded using the device, it should re-encrypt the database with the database key, then securely erase the database key from memory. Appropriately, the device will be configured to consider the user “done”. For example, it might happen when the device is turned off, or when a particular button is pressed, or when there is no user activity for a certain amount of time, or when the user chooses “log-off” from a menu, or a combination of the above arises, etc.

The configuration can be set up to allow changes to the credentials. For example, a password might be set to change every time it is used. A user might be authorized to add new accounts and passwords for new network resources to the credentials database. If the credentials database changes, then the device encrypts the updated database with the database key, and send it back to the credentials server. This can be configured to happen when the user is done, or every time the database changes, or once per hour, or according with a preset schedule.

The above sequence mentioned caching. For each credentials database, the server maintains a version number, that increments each time it receives an update to the credentials database. When a user is done with a device, it will encrypt the credentials database and securely erase the database key. It does not necessarily have to delete the encrypted credentials database, unless the memory space is needed. If there is enough memory available, the database can be retained. The next time the user gives the username, the device can send the credentials server the version number for the database currently in memory. If the server finds that this is still the current version, then it sends back only the encrypted database key, not the entire encrypted database. This saves bandwidth and makes logging in faster for the user. Of course, if many users share the device, the device eventually runs out of memory, and will then start deleting encrypted credentials databases for the users that logged in least recently.

Systems that include large numbers of small, portable, computing devices, which are shared by large numbers of users are very common in a plurality of industries and services providers. For example, a warehouse may have multiple barcode readers shared in common among multiple employees, so that any particular employee may use any of the devices. Any particular device can be used by any of the employees or by a predefined group selected based on a set of parameters. Systems may integrate the devices wireless, or through wired connections, to servers and other network resources. Security is vital for these systems. Security needs to be seamless and capable of securely handling the authentication problem for multiple users sharing multiple devices and accessing multiple online resources. This is an important component for the security infrastructure used in (list all Symbol products generically)

Integration of mobile and non-mobile computing devices in a system usually provides the customer with customer greater power to manage their business, but increases the potential damage due to security breaches. Therefore, customers will demand high security from their systems. The most vulnerable point in any such system is the security of the mobile devices. If workers can access corporate computers through mobile devices, then it will be absolutely vital that attackers cannot attack those computers through stolen mobile devices. Furthermore, customers will need the increased convenience, efficiency, and ease of use that this system provides. A worker will be able to pick up any of a set of authorized devices, authenticate to it just once, then not have to worry about authenticating again while accessing multiple resources and while roaming between different wireless networks. The solution described in the present document provides strong security with the convenience customers demand.

The solution described in the present document revolves around the feature of automatically downloading the credentials databases in ways that are secure and transparent to the user. All mobile systems will have integrated a security solution of this type, especially if they are integrated into a system.

This security solution described in the present document will likely be incorporated into every product that involves network access through mobile computing devices.

It is to be understood that the above description is intended to be illustrative and not restrictive. Many other embodiments will be apparent to one of skill in the art upon reviewing the above description. The scope of the invention should, therefore, be determined with reference to the appended claims, along with the full scope of equivalents which such claims are entitled.

What is claimed is:

1. A method for providing secure access to network resources for a plurality of users, wherein each user utilizes any single device of a device fleet, comprising the steps of:
selecting a device from said fleet of devices accessible to a user;
imputing said user information into said selected device;
transmitting said user information to a credentials database server;
returning an encrypted user specific credentials database to said selected device;
returning to said credential database server an encrypted database key or an acknowledgement;
deciphering said user specific credentials database using said encrypted database key;
accessing with said selected device multiple network resources; and
finalizing use of said selected device.

2. The method of claim 1, for providing secure access to network resources for a plurality of users, wherein each user utilizes any single device of a device fleet, wherein the step of accessing with said selected device multiple network resources comprises:
providing said selected device with one of plurality of possible user specific factors;
determining if the user provided factors match a plurality of preauthorized factors for an authorized user;
retrieving from said selected device memory a randomly generated password for the network resource; and
transmitting the randomly generated password to the network resource to gain access thereto.

3. The method of claim 2, wherein the single device includes an accounts database for storing information required to gain access to the network resource, further comprising adding a network resource to the accounts database.

4. The method of claim 3, further comprising:
accessing the network resource;
receiving from the network resource a template for providing network resource access parameters required to gain access to the network resource;
providing at least one dummy network resource access parameter and any additional required network resource access parameters to the network resource;
storing the network resource template; and
changing the at least one dummy network resource access parameter when the network resource is next accessed.

5. The method of claim 4, further comprising
changing the randomly generated password for the network resource on a predetermined schedule.

6. The method of claim 2, wherein the step of transmitting the randomly generated password to the network resource to gain access thereto further comprises transmitting the randomly generated password in encrypted form.

7. The method of claim 1, for providing secure access to network resources for a plurality of users, wherein each user utilizes any single device of a device fleet, wherein the step of accessing with said selected device multiple network resources comprises:
providing said selected device with one of plurality of possible user specific factors;
determining if the user password and the user biometrics match the password and the biometrics of an authorized user;
using the device dependent key, decrypting the certain operational code or data stored in encrypted form;
retrieving from the device memory the randomly generated password for the network resource; and
transmitting the randomly generated password to the network resource to gain access thereto;
wherein certain operational code or data of the device is stored in encrypted form, and wherein the device includes a device dependent key.

8. A device for providing a user with secure access to a network resource, comprising:
a first module for authenticating a user to said device;
a second module responsive to said first module for providing the user with access to the network resource using a network resource password unknown to the user.

9. The device of claim 8, wherein said first module uses to authenticate the user to said device one of a user password entered by the user, a plurality of user biometrics, and possession of said device.

10. The device of claim 8, further comprising an accounts database for storing information about network resource accessible to an authenticated user.

11. The device of claim 8, wherein said first module is responsive to a user password and a duress password for authenticating the user to said device.

12. The device of claim 11, further comprising:
a duress database; and
an accounts database;
wherein an entry of a correct duress password to authenticate to said device allows said user access only to network resources set forth in said duress database, and
wherein entry of a correct user password to authenticate to said device permits access only to network resources set forth in said accounts database.

13. The device of claim 12,
wherein said network resources set forth in said duress database are those network resources not containing sensitive information, and
wherein said network resources set forth in the accounts database are those to which said user would like to deny access by unauthorized users.

14. The device of claim 9, wherein said device further comprises a biometrics database for storing a plurality of biometrics of authorized device users.

15. The device of claim 14,
wherein said first module is responsive to said plurality of user biometrics for authenticating the user to said device, and
wherein said plurality of biometrics are compared with biometrics stored in said biometrics database, the user being authenticated to the device if a match is found.

16. The device of claim 14, wherein said plurality of user biometrics comprises a fingerprint, a retina scan, a written word, a plurality of written words, and a signature.

17. The device of claim 9, wherein said first module is responsive to the concomitant entry of one of said plurality of biometrics and a user password.

18. The device of claim 17, wherein said device further comprises an entry pad onto which the user inscribes said user password, and
wherein said plurality of user biometrics comprises the characteristics to map said inscribed user password.

19. The device of claim 9, wherein said device further comprises a user password database for storing user passwords of authorized users.

20. The device of claim 19,
wherein said first module is responsive to a user entered password, and
wherein the entered user password is compared with user passwords stored in the user password database for determining whether the user is an authorized user.

21. The device of claim 8, further comprising:
an accounts database for storing network resources information,
wherein an authenticated user has access to network resources stored in said accounts database, and
wherein the second module is responsive to said accounts database for use in accessing the network resource.

22. The device of claim 7, wherein said access information for each network resource includes the network resource address, the network resource user identification, and the network resource password.

23. The device of claim 22, wherein the network resource password is generated using random numbers.

24. The device of claim 23, further comprising an entropy pool including a plurality of random numbers for use in generating the network resource password.

25. The device of claim 22, wherein the network resource password is modified on a predetermined schedule.

26. The device of claim 22, wherein the network resource password is modified each time access is gained to the network resource.

27. The device of claim 8, further comprising:
a communications module for transferring data in encrypted form over a communications link between the device and the network resource.

28. The device of claim 27, wherein the communications link is one of a radio frequency link, an optical link, and an infrared link.

29. The device of claim 27, wherein the communications link comprises the Internet.

30. The device of claim 8,
wherein a computer is interposed between the device and the network resource;
wherein information transferred between the device and the network resource is displayed on the computer, and
wherein certain other information transferred between the device and the network resource is in encrypted form and is not displayed on the computer.

31. The device of claim 8, further comprising
a magnetic code writing module, that is operative to write information to a magnetic strip is a user is authenticated to the device.

32. The device of claim 31,
wherein the information written to the magnetic strip includes credit card information;
wherein the magnetic strip is affixed to a plastic substrate, and
wherein a credit card is formed if the account information is written to the magnetic strip.

33. The device of claim 8, wherein the device size permits hand-held operation of the device.

34. The device of claim 8, wherein the second module logs the device onto the network resource by contacting the network resource and providing the required log-on information without intervention by the user.

35. The device of claim 34,
wherein the log-on information includes the network resource password, and
wherein the network resource password is created by a random process without intervention by the user.

36. The device of claim 8, further comprising a plurality of input modules such as a microphone, a touch-sensitive display screen, a keyboard, and a camera.

37. The device of claim 8, further comprising a plurality of output modules such as speaker, a display, and a printer.

38. The device of claim 8,
wherein a plurality of users are authorized to use a specific device, and
wherein the device further comprises:
an accounts database designating the accounts to which each user has access;
a user password database including the user password for each authorized user, and
a biometrics database including the biometrics for each authorized user; and
wherein said first module is responsive to the user-entered user password and biometrics for comparing the contents of said user password database, and said biometrics database for determining if the user is an authorized user, and in response thereto, authenticating the user to the device, thereby permitting the user to access the designated accounts in the accounts database.

39. The device of claim 8, further comprising a preferences database for storing device operational parameters for the authorized user.

40. The device of claim 39, wherein the device operational parameters include the conditions for changing the network resource password.

41. The device of claim 39, wherein after the user is authenticated to the device, the user can change the preferences stored in the preferences database.

42. The device of claim 8, further comprising
a device dependent key,
wherein the contents of said first and second module are stored in encrypted form, and
wherein said device dependent key is required to decrypt the contents of said first and the second modules.

43. The device of claim 42,
wherein the contents of said first and second module are backed up in encrypted form from the device to a storage module,
wherein said device dependent key is not backed up to said storage module, such that the contents of the first and the second module as stored in said storage module cannot be decrypted.

44. The device of claim 8, further comprising hardware and software elements for performing functions unrelated to accessing a network resource.

45. The device of claim 8, further comprising
a document storage module for storing documents intended for execution by the user,
wherein upon authentication to the device, the user retrieves a document from said document storage module and electronically executes the document.

46. The device of claim 8,
wherein a document is downloaded from the network resource to the device after the user is authenticated, and
wherein the user electronically executes the document and returns the document to the network resource.

47. The device of claim 8,
wherein the network resource is an appliance, and
wherein after the user is authenticated to the device, the device, under user control, communicates with the appliance.

48. The device of claim 47, wherein the device communicates with the appliance by sending a signal for controlling the appliance.

49. The device of claim 47,
wherein after the user is authenticated to the device, the device is operative to send a signal to a computer, and
wherein in response to said signal, the computer controls the appliance.

50. An article of manufacture comprising:
a computer program product comprising a computer-usable medium having a computer-readable code therein for authenticating a user to a device for contacting a network resource, the computer-readable code in the article of manufacture comprising: a computer-readable program code module for receiving a user password;
a computer-readable program code module for receiving biometrics;
a computer-readable program code module for determining if the user password and the user biometrics match the password and the biometrics of an authorized user;
a computer-readable program code module for retrieving a randomly generated password for the network resource; and
a computer-readable program code module for transmitting the randomly generated password to the network resource to gain access thereto.
